(19) United States
(12) Patent Application Publication
(10) Pub. No.: US 2015/0102993 A1
(43) Pub. Date: Apr. 16, 2015

(54) PROJECTOR-CAMERA SYSTEM WITH AN INTERACTIVE SCREEN

(71) Applicant: OMNIVISION TECHNOLOGIES, INC., Santa Clara, CA (US)

(72) Inventors: Hasan Gadjali, Fremont, CA (US); Jin Li, San Jose, CA (US); Jizhang Shan, Cupertino, CA (US)

(73) Assignee: OMNIVISION TECHNOLOGIES, INC, Santa Clara, CA (US)

(21) Appl. No.: 14/050,778

(22) Filed: Oct. 10, 2013

(51) Int. Cl. G06F 3/00; G06F 3/03; G06F 3/038

(52) U.S. Cl. CPC G06F 3/005; G06F 3/038; G06F 3/0304
USPC 345/156

(57) ABSTRACT

A projector-camera system includes a projector coupled to back project a first image on a translucent diffusing screen. A camera is coupled to capture a second image from a back side of the translucent diffusing screen. The second image includes the first image back projected on the translucent diffusing screen and a shadow of a pointing device cast on a front side of the translucent diffusing screen. The pointing device is on the front side of the translucent diffusing screen and is in close proximity to the translucent diffusing screen. A processing block is coupled to the projector and the camera to generate a third image including the shadow of the pointing device. The processing block is further coupled to activate a command in a main computer coupled to the processing block in response to a relative position of the shadow of the pointing device in the third image.

### BACKGROUND INFORMATION

1. Field of the Disclosure

The present invention relates generally to an interactive screen, and more specifically, to projector-camera system with an interactive screen.

2. Background

Tablet computers have become increasingly popular. A tablet computer typically includes a flat touch screen display and no mechanical keyboard. A tablet computer is typically a thin flat 3D rectangular shape that can held or be put on top of a table or other supporting surface. In addition to performing regular computation tasks such as word processing and scientific computing, a tablet computer is also used commonly for games and other applications that require interaction between the user and the computer through the touch screen display.

A larger touch screen display can sometimes enhance the interaction between the user and the computer. However, the cost of the flat display increases exponentially as the size of the display increases. A larger touch screen display may need a larger glass substrate, more pixels, and more touch screen sensors. A larger touch screen display also needs more power to illuminate the display.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram of a traditional tablet computer.

FIG. 2A is a diagram of an example projector-camera system with an interactive screen in accordance with the teachings of the present invention.

FIG. 2B is a diagram of another example projector-camera system with an interactive screen in accordance with the teachings of the present invention.

FIG. 2C is a diagram of yet another example projector-camera system with an interactive screen in accordance with the teachings of the present invention.

FIG. 3 illustrates operation of an example projector-camera system with an interactive screen in accordance with the teachings of the present invention.

FIG. 4 illustrates still another example of a projector-camera system with an interactive screen in accordance with the teachings of the present invention.

FIG. 5A illustrates an example of an image projected onto a screen in accordance with the teachings of the present invention.

FIG. 5B illustrates an example of an image captured by a camera including a projected image and a shadow of a finger in accordance with the teachings of the present invention.

FIG. 5C illustrates an example of a shadow of a hand and finger alone resulting from example processing of a projected image and a captured image in accordance with the teachings of the present invention.

FIG. 5D illustrates an example of a sharp point resulting from example processing of a projected image and a captured image in accordance with the teachings of the present invention.

FIG. 6 illustrates an example block diagram illustrating operation of an example projector-camera system with image subtraction in accordance with the teachings of the present invention.

FIG. 7 is a diagram of an example projector-camera system with an interactive screen included in an example enclosure in accordance with the teachings of the present invention.

Corresponding reference characters indicate corresponding components throughout the several views of the drawings Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Example methods and apparatuses directed to a projector-camera system with an interactive screen are disclosed. As will be appreciated, a projector-camera system with an interactive screen according to the teachings of the present invention may include a projector that projects an image onto a screen. A user may interact with screen using one or more pointing devices and a camera that captures the interactions with the screen. Since the interactive screen is provided using an image that is projected by the projector onto the screen, an increase in size of the screen does not significantly increase the cost of the interactive screen.

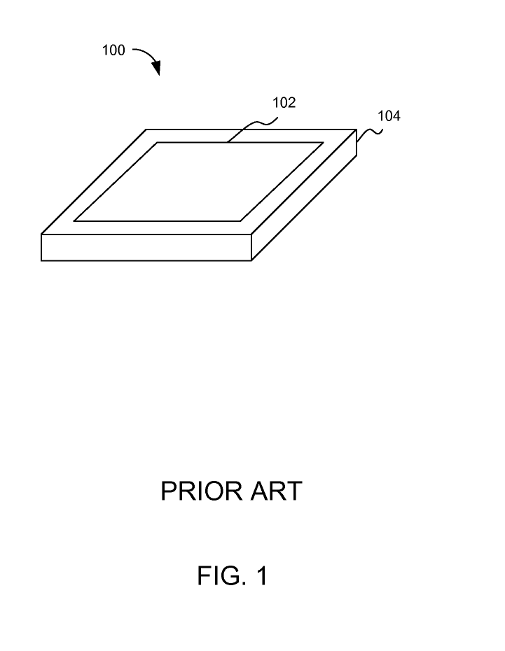

To illustrate, FIG. 1 is a schematic diagram of a traditional tablet computer 100 including a touch screen display 102 and a main computer 104. Main computer 104 includes a CPU (central processing unit), RAM (random access memory), ROM (read only memory), and other parts of a computer. To enhance the interaction between a user (not shown) and main computer 104, a larger touch screen display 102 may be preferred.

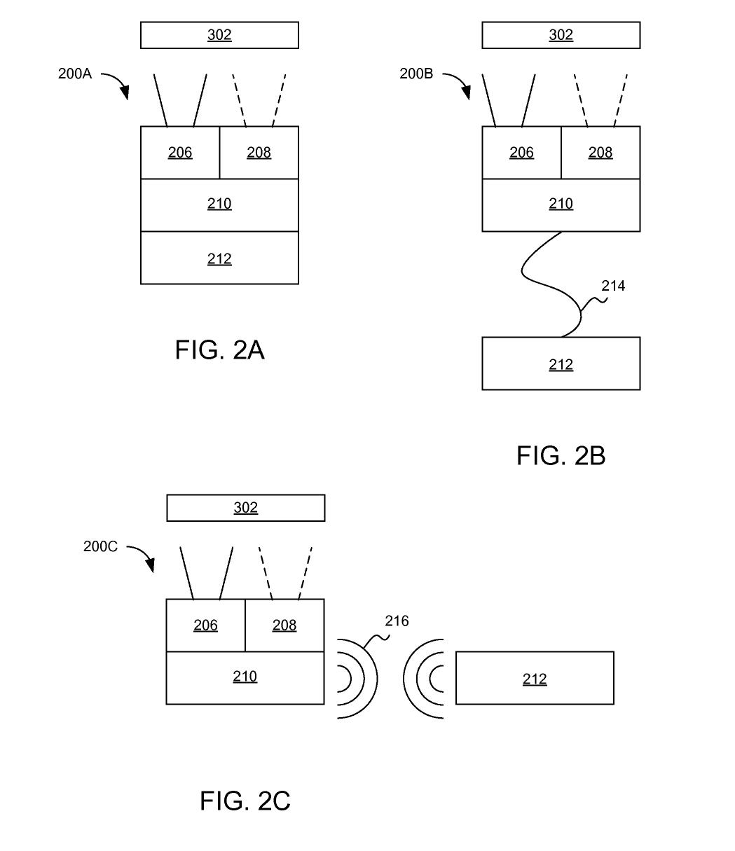

FIG. 2A is a diagram of an example projector-camera system 200A with an interactive screen 302 in accordance with the teachings of the present invention. As shown in the depicted example, projector-camera system 200A may include a projector 206, a screen 302, a camera 208, and a processing block 210 coupled to the projector 206 and the camera 208. In one example, projector 206 may include an LCOS (liquid crystal on silicon) projection display panel to back project an image onto screen 302. In one example, the LCOS based projector 206 may be a pico projector. Camera 208 may include a CMOS (complementary metal oxide semiconductor) image sensor.

In one example, projector-camera system 200A may also include a main computer 212 coupled to processing block 210 and included in the same housing as shown in FIG. 2A. In one example, main computer 212 includes a CPU, RAM, ROM, and other parts of a computer.

In another example, main computer 212 may be coupled to processing block 210 in a projector-camera system 200B through a cable 214 as shown in the example depicted in FIG. 2B in accordance with the teachings of the present invention.

In yet another example, main computer 212 may also be coupled to processing block 210 in a projector-camera system 200C by a wireless connection 216 as shown in FIG. 2C in accordance with the teachings of the present invention

In other examples, it is appreciated that processing block 210 may be included and integrated in main computer 212. Since a projection screen 302 is used instead of a touch screen display, such as for example touch screen display 102 of FIG. 1, the magnification and distance of the projector 206 to the projection screen 302 determines the effective size of the display. Thus, a cost savings for screen 302 may be achieved in accordance with the teachings of the present invention when compared to a comparably sized touch screen display, such as for example touch screen display 102 of FIG. 1.

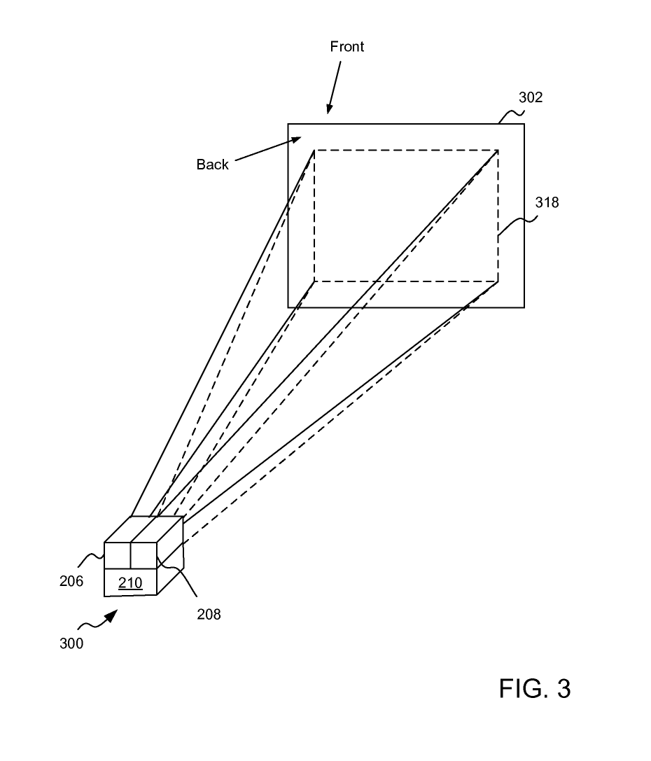

FIG. 3 illustrates operation of an example projector-camera system 300 with an interactive screen 302 in accordance with the teachings of the present invention. It is appreciated that the example projector-camera system 300 of FIG. 3 may be an example of projector-camera system 200A, 200B, or 200C as discussed above in FIG. 2. Accordingly, it should be appreciated that similarly named and numbered elements referenced below are coupled and function as described above. In one example, projector 206 and camera 208 are disposed close together in projector-camera system 300. For example, projector 206 and camera 208 are disposed directly next to each other. Projector-camera system 300 may also include processing block 210.

As shown in the example depicted in FIG. 3, an image 318 is back projected by projector 206 onto a back side of screen 302. In one example, screen 302 may be a translucent diffusing screen or the like, and a user (not shown) may therefore observe projected image 318 from the front side of translucent diffusing screen 302. In one example, the back side of translucent diffusing screen 302 also partially reflects the light of incoming image 318 that is projected from projector 206 such that the projected image 318 is visible to camera 208. Thus, projected image 318 that is reflected from translucent diffusing screen 302 may then be captured by camera 208 from the back side of translucent diffusing screen 302 in accordance with the teachings of the present invention.

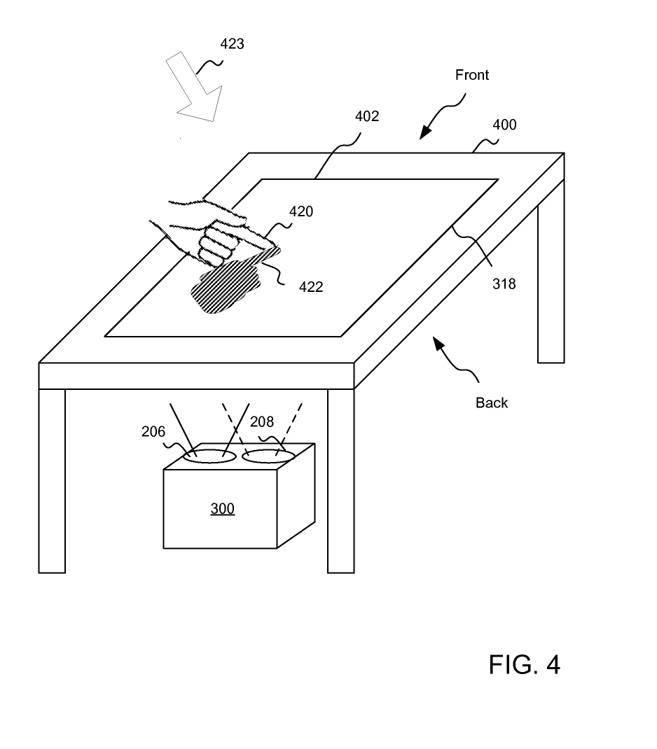

FIG. 4 illustrates still another example of a projector-camera system 300 with an interactive screen in accordance with the teachings of the present invention. In particular, FIG. 4 illustrates an example in which projector-camera system 300 is disposed under a table 400 that includes a translucent diffusing screen 402. In one example, table 400 may be a coffee table, a desk, a countertop, or the like. As shown in the depicted example, projector 206 back projects image 318 onto a translucent diffusing screen 402 on table 400, such that projected image 318 can be observed from above table 400 by a user (not shown) that observes the projected image from the front side of translucent diffusing screen 402. The user (not shown) may position his or her finger or any plurality of pointing devices 420 in contact with or near the front side of translucent diffusing table top screen 402 to interact with translucent diffusing screen 402 as shown and therefore activate a command or a plurality of commands in projector-camera system 300 in accordance with the teachings of the present invention. In various examples, it is appreciated that plurality of pointing devices 420 may include one or more pens, pencils, styluses, fingers or the like under the control of one or more users. The back side of translucent diffusing screen 402 partially reflects the light of image 318 projected from projector 206, such that projected image 318 is captured by camera 208 from the back side of translucent diffusing screen 402.

As shown in the example illustrated in FIG. 4, a shadow 422 is cast by finger 420 of the user from light 423. In one example, light 423 illuminates the front side of translucent diffusing screen 402, and may include ambient light or may be provided from any suitable light source that illuminates the front side of that translucent diffusing screen 402 and casts shadow 422, which in one example appears as a silhouette of finger 420 on screen 402. Thus, it is appreciated that finger 420 is located between the source of light 423 and the front side of translucent diffusing screen 402. It is noted that although only one finger 420 is illustrated in FIG. 4, finger 420 may be one of a plurality of pointing devices as described previously. In one example, if finger 420 is positioned to be in close proximity to translucent diffusing screen 402, the relative positions of finger 420 and the shadow 422 that is cast by finger 420 onto the front side of translucent diffusing screen 402 are substantially the same on translucent diffusing screen 402. It is appreciated that positioning finger 420 in close proximity to translucent diffusing screen 402 includes positioning finger 420 to be in contact with (i.e., touching) translucent diffusing screen 402. As shown in the illustrated example, camera 208 is focused on the back side of translucent diffusing screen 402. As such, camera 208 images both image 318 projected on the back of translucent diffusing table top screen 402 as well as shadow 422 cast onto the translucent diffusing screen 402 in accordance with the teachings of the present invention.

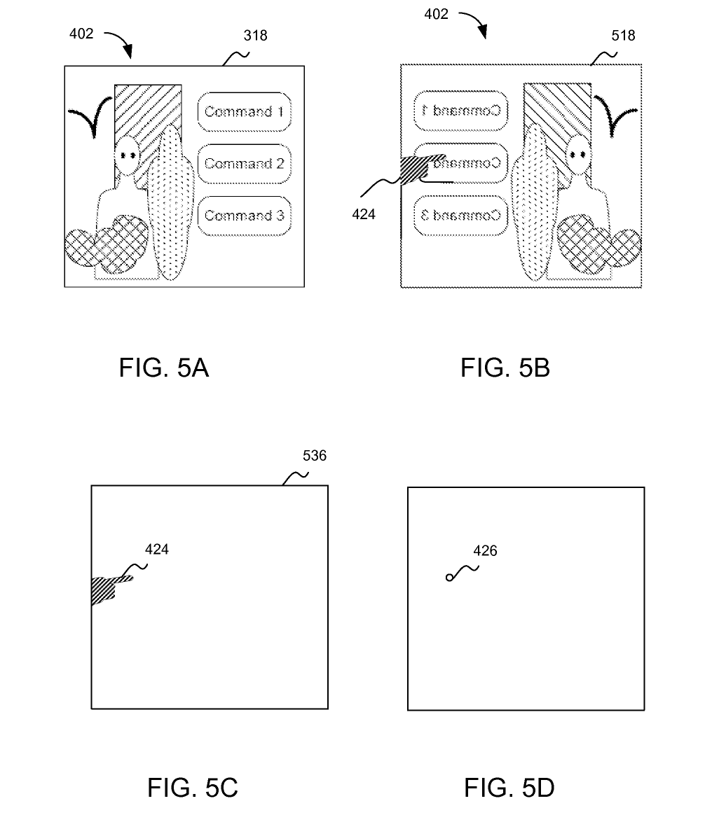

FIG. 5A illustrates an example of an image back projected onto a screen in accordance with the teachings of the present invention. In particular, FIG. 5A illustrates an example of back projected image 318 as observed from the front side of the translucent diffusing screen 402 in accordance with the teachings of the present invention. FIG. 5B illustrates an image 518 captured by camera 208 from the back side of translucent diffusing screen 402. As shown in the depicted example, image 518 as captured by camera 208 from the back side of translucent diffusing screen 402 is a reversed image with respect to image 318 as observed from the front side of translucent diffusing screen 402.

In addition, as shown in the depicted example, an image 424 of shadow 422 (not shown) that is cast by finger 420 (not shown) onto the front side of translucent diffusing screen 402 is also observed in image 518, which is captured by camera 208 from the back side of translucent diffusing screen 402 in accordance with the teachings of the present invention. In the example illustrated in FIG. 5B, shadow 422 is representative of a shadow that is cast by one finger. It is appreciated that although only one finger is illustrated in FIG. 5B, shadow 422 may be one of a plurality of shadows that are cast by a plurality of pointing devices from the front side of translucent diffusing screen 402 in accordance with the teachings of the present invention as described previously. In the example, all of the shadows may be processed simultaneously by processing block 210 as discussed above in accordance with the teachings of the present invention.

For instance, in one example, processing block 210 processes the projected image 318 and captured image 518 to isolate the shadow 422 that is cast by the finger 420 from the front side, resulting in image 424, which is obtained by subtracting the projected image 318 from captured image 518 in accordance with the teachings of the present invention. It is illustrated as a processed image 536 in FIG. 5C, in accordance with the teachings of the present invention. Although the actual finger 420 may not be directly visible in FIGS. 5A-D, the position of finger 420 relative to projected image 318 can be determined in response to the image 424 of the shadow 422 cast by finger 420 in accordance with the teachings of the present invention. For instance, as finger 420 comes into contact with or in close proximity to the region of Command 2 as shown for example in FIG. 5B, the image 424 within the region associated with Command 2 becomes more readily apparent to processing block 210 in accordance with the teachings of the present invention.

It is appreciated that a command is not necessarily limited to a button shaped region as illustrated in the examples depicted in FIG. 5A and FIG. 5B. A command may be represented in any shape or any graphic at a certain location, and the location represents the command in accordance with the teachings of the present invention. For example, in a game, the location of the command may be the location of a bouncing ball such that the locations vary in every frame.

It is appreciated that the precise position touched by or close to finger 420 may be determined further by image processing within processing block 210 in accordance with the teachings of the present invention. For example, the image processing within processing block 210 may transform the 2D image 424 of shadow 422 cast by finger 420 to obtain a sharp point 426 representative of a location of image 424 of shadow 422 as shown in FIG. 5D in accordance with the teachings of the present invention. The sharp point 426 may for example represent the tip of the finger 420 and the image processing performed by processing block 210 to determine the precise location of sharp point 426 may be based on an image processing correlation algorithm.

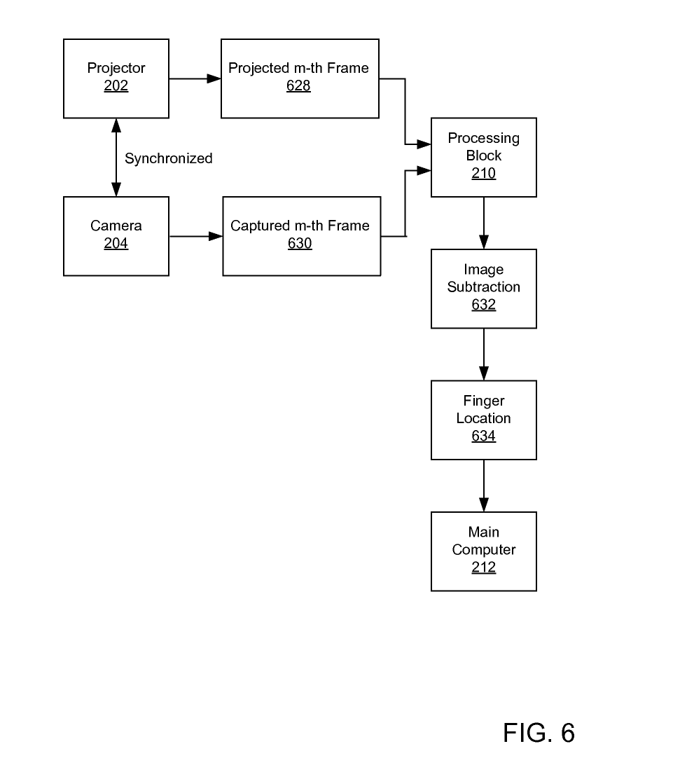

FIG. 6 illustrates an example block diagram illustrating operation of an example projector-camera system with image subtraction in accordance with the teachings of the present invention. As shown in the depicted example, projector 206 and camera 208 are synchronized. Projector 206 inputs a projected m-th frame 628 to processing block 210. Camera 208 inputs a captured m-th frame 630 to processing block 210. The size and orientation of projected m-th frame 628 and the size and orientation of captured m-th frame 630 are equalized and aligned by projector 206, camera 208, or processing block 210. After the size and orientation of projected m-th frame 628 and the size and orientation of captured m-th frame 630 are equalized and aligned, projected m-th frame is subtracted from captured m-th frame in processing block 210. In one example, an image subtraction 632 may be provided by processing block 210. From image subtraction 632, finger location 634 can be determined as described above for example in FIGS. 5A-5D. Finger location 634 is output to main computer 212. Finger location 634 provides the position of part of projected image 318 that is touched by or close to finger 420, for example the position of Command 2 as shown in FIG. 5B. Accordingly, Command 2 will be activated by main computer 212 in accordance with the teachings of the present invention.

It is appreciated that image 318 back projected by projector 206 may include a plurality of commands disposed at different positions as shown for example in FIG. 5A. For example, Command 1 at region 1, Command 2 at region 2, Command 3 at region 3, etc. If the finger touches or if the finger is in close proximity to region 1, then Command 1 is selected. If, for example, two pointing devices touch or if two pointing devices are close to or within two regions, such as for example Command 1 and Command 2, then both Command 1 and Command 2 may be activated.

Furthermore, main computer 212 or processing block 210 may determine how long, i.e., how many frames, finger 420 at a certain position of a command to activate the command. Similarly, main computer 212 or processing block 210 may determine how long, i.e., how many frames, finger 420 within a region of the command to ignore the presence of finger 420 within the region.

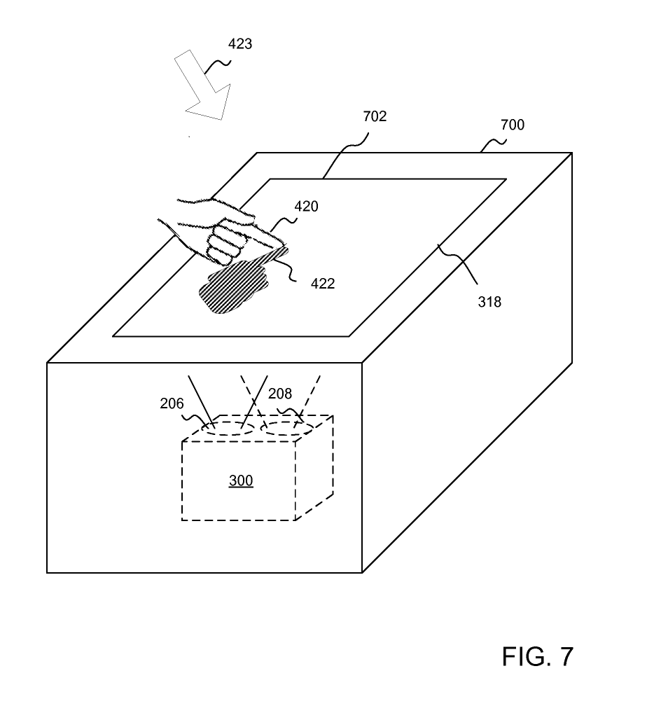

FIG. 7 is a diagram of an example projector-camera system 300 with an interactive screen included in an example enclosure in accordance with the teachings of the present invention. Projector-camera system 300 is inside an enclosure 700 having a translucent diffusing screen 702. Projector 206 in projector-camera system 300 projects image 318 onto the back of translucent display screen 702. A user (not shown) may touch translucent diffusing screen 702 using his finger or pointing devices 420, or may place his finger or pointing devices 420 close to the front side of translucent diffusing screen 702. Camera 208 in projector-camera system 300 captures back projected image 318 and shadow 422 of finger or pointing devices 420 formed on the front side of translucent diffusing screen 702 in accordance with the teachings of the present invention.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. A projector-camera system, comprising:
a projector coupled to back project a first image on a translucent diffusing screen;
a camera coupled to capture a second image from a back side of the translucent diffusing screen, wherein the second image includes the first image back projected on the translucent diffusing screen and a shadow of a pointing device cast on a front side of the translucent diffusing screen, wherein the pointing device is on the front side of the translucent diffusing screen and is in close proximity to the translucent diffusing screen; and
a processing block coupled to the projector and the camera to subtract the first image from the second image to generate in a third image including the shadow of the pointing device, wherein the processing block is further coupled to equalize and align a size and orientation of the first image is with respect to the second image prior to subtracting first image from the second image, wherein the processing block is further coupled to provide a command to a main computer coupled to the processing block in response to a relative position of the shadow of the pointing device in the third image.

2. The projector-camera system of claim 1 wherein the pointing device is one of a plurality of pointing devices.

3. The projector-camera system of claim 1 wherein the pointing device includes a finger of a user.

4. The projector-camera system of claim 1, wherein the pointing device is in contact with the translucent diffusing screen.

5. The projector-camera system of claim 1, wherein the processing block is further coupled to transform the shadow of the pointing device in the third image to obtain a sharp point.

6. The projector-camera system of claim 5, wherein the processing block is coupled to utilize an image processing correlation algorithm to transform the shadow of the pointing device in the third image to obtain the sharp point.

7. The projector-camera system of claim 1 wherein the main computer is included in the projector-camera system.

8. The projector-camera system of claim 1 wherein the main computer is coupled to the processing block by a cable.

9. The projector-camera system of claim 1 wherein the main computer is coupled to the processing block by a wireless connection.

10. The projector-camera system of claim 1 wherein the back side of the translucent diffusing screen partially reflects incoming light.

11. The projector-camera system of claim 1 wherein the translucent diffusing screen included in a table.

12. The projector-camera system of claim 1 wherein the projector-camera system is included in an enclosure including the translucent diffusing screen.

13. The projector-camera system of claim 1 wherein the projector is a pico projector including a liquid crystal on silicon (LCOS) projection display panel.

14. A method of interacting with a screen, comprising:
projecting a first image onto a back side of a translucent diffusing screen;
casting a shadow on a front side of the translucent diffusing screen with a pointing device on the front side of the translucent diffusing screen;
capturing a second image from the back side of the translucent diffusing screen including the shadow cast on the front side of the translucent diffusing screen with the of pointing device;
isolating the shadow cast with the of pointing device on the front side of the translucent diffusing screen;
determining whether a location of the shadow cast on the front side of the translucent diffusing screen with the of pointing device is within a region of a first command; and
activating the first command if the location of the shadow cast on the front side of the translucent diffusing screen is within the region of the first command.

15. The method of interacting with the screen of claim 14 further comprising illuminating the front side of the translucent diffusing screen with light to cast the shadow on the front side of the translucent diffusing screen with the of pointing device.

16. The method of interacting with the screen of claim 14 further comprising equalizing and aligning a size and orientation of the first image is with respect to the second image prior to isolating the shadow cast on the front side of the translucent diffusing screen with the of pointing device.

17. The method of interacting with the screen of claim 14 wherein isolating the shadow cast with the pointing device on the front side of the translucent diffusing screen comprises obtaining a third image by subtracting the first image from the second image.

18. The method of interacting with the screen of claim 14 further comprising transforming the third image to obtain a sharp point representative of the location of the shadow cast on the front side of the translucent diffusing screen with the of pointing device.

19. The method of interacting with the screen of claim 14 wherein the pointing device is one of a plurality of pointing devices and the shadow is one of a plurality of shadows cast by the plurality of pointing devices on the front side of the translucent diffusing screen.

20. The method of interacting with the screen of claim 18 further comprising:
isolating a second one of the plurality of shadows cast by a second one of the plurality of pointing devices on the front side of the translucent diffusing screen;
determining whether a location of the second one of the plurality of shadows cast by a second one of the plurality of pointing devices on the front side of the translucent diffusing screen is within a region of a second command; and
activating the second command if the location of the shadow cast on the front side of the translucent diffusing screen is within the region of the first command.
